(19) United States
(12) Patent Application Publication
(10) Pub. No.: US 2017/0072330 A1
(43) Pub. Date: Mar. 16, 2017

(54) Responsive Construction Toy

(71) Applicant: University of Rochester, Rochester, NY (US)

(72) Inventors: Randal Crosby Nelson, Rochester, NY (US); Eric Solomon Frank, Brooklyn, NY (US)

(73) Assignee: University of Rochester, Rochester, NY (US)

(21) Appl. No.: 15/263,331

(22) Filed: Sep. 12, 2016

Related U.S. Application Data
(60) Provisional application No. 62/218,530, filed on Sep. 14, 2015.

(51) Int. Cl. A63H 33/04; F21V 7/00; G09B 19/00; F21V 33/00; A63H 33/22; A63H 33/08

(52) U.S. Cl. CPC A63H 33/042; A63H 33/22; A63H 33/088; G09B 19/0069; F21V 33/008; F21V 7/0091; A63H 2200/00; F21Y 2115/10

(57) ABSTRACT

A responsive construction toy is disclosed. The responsive construction toy, also known as LumenLinks™, comprises at least one active rod and at least one connector. The active rod has an optics end and a push-pull transducer. The active rod illuminates with varying intensity and color to signify magnitude and direction of force on the active rod. Three dimensional structures such as trusses, buildings, and towers can be built by connecting active rods and connectors. When a structure is built, the forces on each active rod can be visually interpreted, thus providing an educational toy that has both tangible and concrete elements as well as responsiveness and feedback.

### CROSS REFERENCE TO RELATED PATENT APPLICATIONS

This application, claims priority to U.S. Patent Application Ser. No. 62/218,530 filed Sep. 14, 2015 entitled “Responsive Construction Toy” by Randal Crosby Nelson mid Eric Solomon Frank, the entire disclosure of which is incorporated herein by reference.

### BACKGROUND OF THE INVENTION

1. Field of the Invention

The present invention relates generally to toys, and more particularly to a responsive and tangible construction toy.

2. Description of the Related Art

Construction toys have been around for many years, often with wood, metal and plastic connectors that serve to inspire creativity, free expression and the feeling of satisfaction that results from building a tangible item from a construct in one's mind. These tangible construction toys often employ repetitive pieces that can be connected together in two or three dimensions to create structures that range from simple to elaborate. While these tangible construction toys develop valuable cognitive and tangible skills, they lack feedback of underlying engineering and physics principles such as stress and strain. Feedback from the tangible construction toy, if any, is very binary—either the structure being built stands or falls. The interplay between forces in a structure being built is not apparent, and remains intangible and elusive to most children who play with these construction toys.

With the widespread use of electronic devices such as computers, smart phones, tablets, and the like, many educational construction games are now available. These electronic games provide more feedback and responsiveness to the user, but lack the concreteness and social element of the traditional tangible construction toy made of wood, metal or plastic.

What is therefore needed is a construction toy that is tangible and concrete, yet has responsiveness and feedback on fundamental engineering principles to provide valuable hands on learning opportunities that are not possible with either computer based games or traditional tangible construction toys.

### BRIEF SUMMARY OF THE INVENTION

In accordance with the present invention, there is provided a responsive construction toy comprising at least one active rod and at least one connector. A plurality of active rods and connectors can be assembled into structures. The active rods have an optics end and a push pull transducer end and illuminate with varying intensity and color dependent on the magnitude and direction of force applied to it. The connectors provide mechanical and electrical continuity between active rods.

The foregoing paragraph has been provided by way of introduction, and is not intended to limit the scope of the invention as described by this specification, claims and the attached drawings.

### BRIEF DESCRIPTION OF THE DRAWINGS

The invention will be described by reference to the following drawings, in which like numerals refer to like elements, and in which:

FIG. 1 is a plan view of an example of a responsive construction toy built item of the present invention;

FIG. 2 is a perspective view of an X-Y connector of the present invention;

FIG. 3 is a plan view of the X-Y connector of FIG. 2;

FIG. 4 is a plan view of a Z connector of the present invention;

FIG. 5 is a perspective view of an active rod of the present invention;

FIG. 6 is a plan view of the end of a plug of the active rod of FIG. 5;

FIG. 7 is a partial cross sectional view of the push-pull transducer end of the active rod taken along line A-A of FIG. 6;

FIG. 8 is a partial cross sectional view of the optics end of the active rod taken along line A-A of FIG. 6;

FIG. 9 is a plan view of an active rod with two X-Y connectors under compression;

FIG. 10 is apian view of an active rod with two X-Y connectors under tension;

FIG. 11 is apian view of an example of a responsive construction toy built item of the present invention;

FIG. 12 is a plan view of an example of a responsive construction toy built item of the present invention;

FIG. 13 is a plan view of an example of a responsive contraction toy built item of the present invention;

FIG. 14 is an exploded perspective view of an active rod of the present invention; and

FIG. 15 is a circuit diagram of the push-pull transducer electronics of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims and drawings attached hereto.

### DESCRIPTION OF THE PREFERRED EMBODIMENTS

A Responsive Construction Toy is described herein. The construction toy combines tangible and concrete elements with responsiveness and feedback that fosters an understanding of engineering principles that has heretofore not been possible.

The Responsive Construction Toy of the present invention will hereinafter also be referred to as LumenLinks™, with both names being fully interchangeable throughout this disclosure. Prior to turning to the drawing, a brief overview of LumenLinks™ is provided.

Interaction with LumenLinks™ from a purely mechanical standpoint should be intuitive to most children, as it follows the repetitive construction element approach of many construction related toys on the market. A child starts building a structure with LumenLinks™ by connecting one or more active rods to a base station or to each other by way of the connectors described herein. The base station may not be necessary in some embodiments of the present invention. The base station is a flat grid of plugs which provide power and communication to the first set of active rods that are placed. Through this first set of active rods, power and communication is provided to the rest of the structure. The child continues building based on this foundation of active rods, appending connector pieces such as X-Y connectors and Z connectors to the established active rods and then adding more active rods to those connector pieces. The child continues to add active rods and connectors until such time as the child wishes to test the integrity of the structure that has been built. The child may choose a material for the active rods to simulate (for example wood, steel or aluminum), from a dial on the base station, power feed, or the like. The child then presses a ‘test’ button that feeds power from the base through the network of active rods and connectors, activating the feedback element and “breathing life” into the toy. Each active rod emits red light if it is under compression or green if it is under tension, in

some embodiments of the present invention with a brightness that varies with the intensity of applied force relative to the capacity of the chosen material. Other colors may also be employed, and are simply considered embodiments of the present invention. In addition, sounds and other sensory effects may also be employed. If stress on an active rod exceeds its rated capacity it provides feedback to the user, for example, it flashes red or green corresponding to failure in compression, or tension. Sound may also be incorporated. The child can push, pull, or otherwise apply loads to the created structure and observe the results. On a large scale, the child then sees a “heat map” of forces on the structure and is able to quickly locate critical elements. The child can also associate hot spots of forces and their resulting stress or strain, along with breakpoints that may appear totally unrelated or spatially distant. Each LumenLinks™ set comprises active rods and connector pieces. The active rods are made of a transparent or translucent material such as a plastic tube (for example, acrylic or polycarbonate) fitted with miniature or scaleable electronic and optical components. The connectors are made of three alternating, concentric layers of conductive metal and insulating material, with holes penetrating all layers, into which the connectors of the active rods plug into. Each active rod contains a compression and tension sensing unit with LEDs or similar light sources contained therein. The light produced by the LEDs propagates down the tube walls via total (or partial) internal reflection and is incrementally scattered out the sides by textured zones, producing a visible, illuminated pattern. The inside of the tube provides passage for wires or similar conductors. Each end of the rod has a specially designed plug with three prongs, two for power and signals, and one for ground; these plugs insert into the conductive connector pieces, making contact with the metal rings inside. Each contact on the plug has a protruding dimple spaced such that it touches the correct conductive ring in the connector, providing a compression contact. The contacts may also be spring loaded or otherwise provide pressure to ensure good mechanical and electrical contact. The concentric conductors in the connectors allow the affixed active rods to be freely rotated axially with respect to the connector while maintaining electrical connectivity. This provides freedom to construct non-planar structures. Further non-planar freedom is provided by Z connectors that can be affixed to the face of the X-Y connector disks, providing non-planar connections at a single point, which are needed for realistic 3-D trusses and other load-bearing structures. Connectors may be provided with a plurality of sockets, such as 6 or 8 sockets, allowing for a variety of truss designs. Power for the system may be provided by a supportive base station or a power feed. Plugs may be distributed in a grid along the surface of the base station, when so employed. When a Z connector is snapped into a plug on the base it powers active rods that feed into the rest of the network. The same network can also be used to send simple programming information that allows adjustment of active rod parameters. Push-pull transducers are attached to each active rod. Force sensing in the push-pull transducers is accomplished, in one embodiment of the present invention by flat, pressure-sensitive resistors inserted into a mechanical linkage that separates compression and tension. An electronic circuit maps sensor readings to LED activity. The circuit also contains circuitry allowing rod parameters to be set by signals transmitted discretely or modulated on top of the power network.

With the above overview in mind, and now turning to the drawings, a complete disclosure of the present invention and the various embodiments described and envisioned herein is provided.

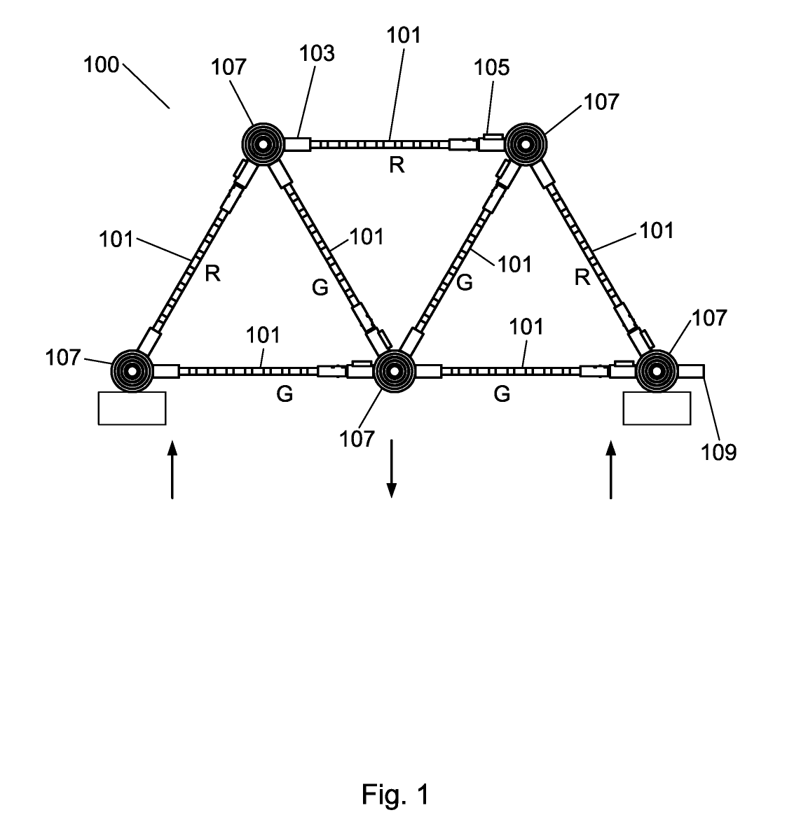

The responsive construction toy of the present invention comprises an active rod 101 as seen in FIG. 1 and various connectors. The connectors may be X-Y connectors 107 as seen in FIG. 1, or may, in some embodiments of the present invention, include Z connectors 401, as seen in FIG. 4.

Turning first to FIG. 1, a plan view of an example of a responsive construction toy built tem of the present invention is depicted. Active rods 101 can be seen connected to X-Y connectors 107. In addition, the optics end 103 and the push-pull transducer end 105 can be seen with each active rod 101. The sample truss section that is depicted in FIG. 1 shows force arrows as well as a power feed 109 that provides electrical power to the assembled item and also, in some embodiments of the present invention, signaling and control signals. Each of the components depicted in FIG. 1 will be described in further detail herein.

As previously stated, the connectors that join the active rods 101 together include X-Y connectors 107 as well as Z connectors 401. The Z connectors are a “half connector” of sorts, allowing for the construction of three dimensional structures.

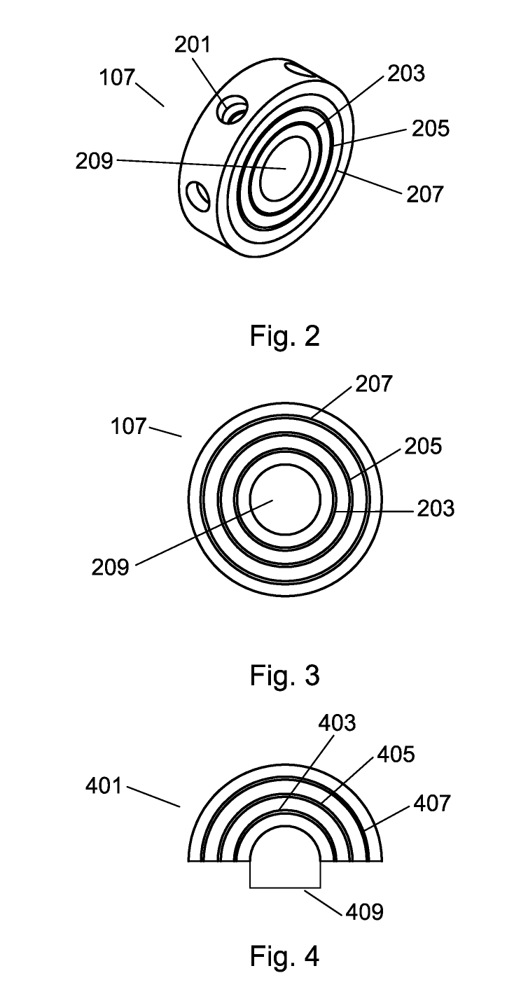

FIG. 2 is a perspective view of an X-Y connector 107. The X-Y connector 107 comprises a series of concentric conductive rings, for example, a first conductive ring 203, a second conductive ring 205, and a third conductive ring 207. The conductive rings are made from a metal such as copper, brass, steel, stainless steel, or the like, and are separated by an insulator such as a plastic, ceramic, or the like. A plurality of X-Y sockets 201 are provided circumferentially about the X-Y connector 107 and pass radially inward. In some embodiments of the present invention, there may be six or eight X-Y sockets 201. Each X-Y socket 201 is configured to receive a plug from an active rod 101, and the concentric conductive rings provide power, ground, and communication to the active rods 101 that are connected therewith. The X-Y connectors 107 also have a Z socket 209 for receiving a Z connector 401, as further depicted in FIG. 4. The Z socket 209 may be concentric with the conductive rings 203, 205 and 207, and may be in the center of the X-Y connector 107.

FIG. 3 is a plan view of the X-Y connector of FIG. 2, clearly showing the conductive rings 203, 205, and 207, and the insulating material between each of the conductive rings. The Z socket 209 may pass completely through the X-Y connector 107, or may, in some embodiments of the present invention, pass only partially through the X-Y connector 107, have baffles, spacers, ridges, grooves, walls, partitions, or the like.

FIG. 4 is a plan view of a Z connector 401. The Z connector is a “half connector” of sorts, having a first conductive arc 403, a second conductive arc 405, and a third conductive are 407. The conductive arcs provide electrical contact to other X-Y connectors 107 or to active rods 101 directly, and are made from a metal such as copper, brass, steel, stainless steel, or the like, and are separated by an insulator such as a plastic, ceramic, or the like. Although not seen in FIG. 4, sockets similar to the X-Y sockets 201 of the X-Y connector 107 are provided circumferentially about the Z connector 401 and pass radially inward. In some embodiments of the present invention, there may be three or four sockets, each similar to the sockets 201 depicted in FIG. 2. Each socket is configured to receive a plug from an active rod 101, and the concentric conductive arcs provide power, ground, and communication to the active rods 101 that are connected therewith. The Z connector 401 is a half of an X-Y connector with a Z plug 409 for connection with a Z socket 209 of an X-Y connector 107. The Z plug may be made from a plastic, a metal, or other suitable material, and may have further features such as ridges, pins, clips, or the like, to facilitate placement and retention in the Z socket 209 of the X-Y connector 107.

In addition to the X-Y connectors and the Z connectors, active rods 101 comprise an essential component of the present invention. The active rods 101 provide linear connections between each of the connectors in the system, and are structural components that may be under tension or compression (or in some cases neutral it), depending on the structure being built. An active rod 101 comprises a plug on each end (a first plug 509 and a second plug 515), an optics end 103 and a push-pull transducer end 105. In some embodiments of the present invention, the optics 103 and the push-pull transducer 105 are not physically located at an end of the active rod, but may be located at any point along the length of the active rod or even along the length of the elongated member of the active rod or contained therein.

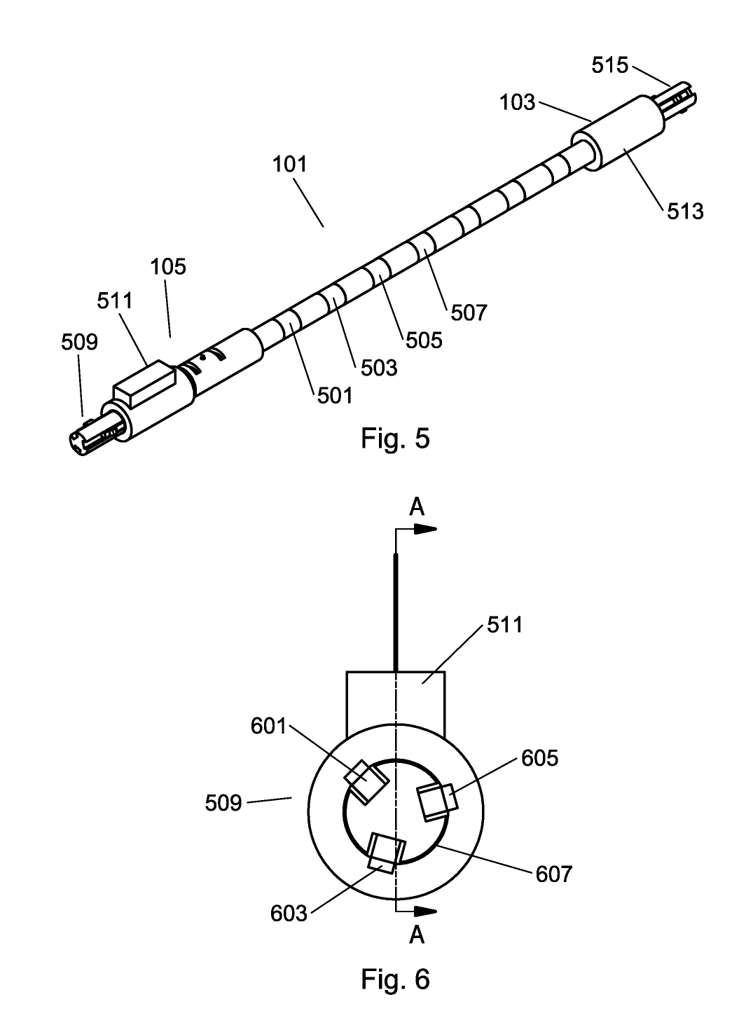

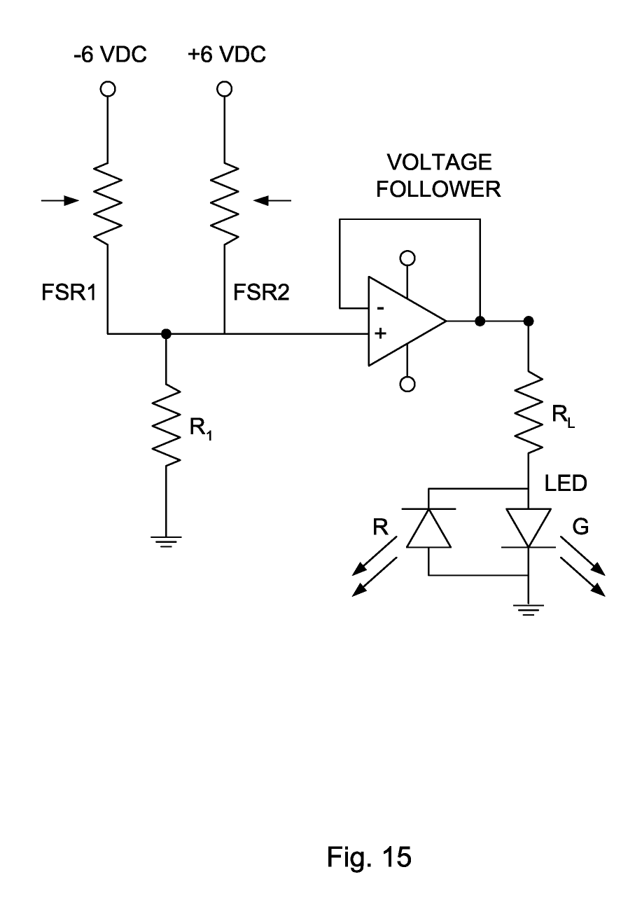

FIG. 5 is a perspective view of an active rod of the present invention. The active rod 101 is made from a plastic tube or similar elongated member that may, in some embodiments of the present invention, be thick walled or solid. The plastic is transparent or translucent or otherwise has optically suitable properties. An acrylic or polycarbonate material is an example of such an optically suitable material. The active rod 101 may, in some embodiments of the present invention, have light transmission bands, such as those seen in FIG. 5, 501-507. The light transmission bands may be a textured or otherwise optically transmissive surface such that light originating in the optics end 103 propagates down the tube via internal reflection and is incrementally scattered out the sides through these textured transmission bands, producing a visible, illuminated pattern. The inside of the active rod also provides for the passage of wires or conductive traces to pass power and signaling from one end of the active rod 101 to the other. A first plug 509 and a second plug 515 can be seen. Each plug has three prongs, two for power and signals, and one for ground. Each prong has a protruding bend, dimple, or similar feature such that when the plug 509 or 515 is inserted into a socket on an X-Y connector 107 or a Z connector 401, it makes contact with the appropriate concentric ring or arc. This specialized plug and related connector allow the active rods to rotate freely about their axis while still maintaining electrical connectivity. A push-pull transducer 105 is connected to one end of the active rod, and provides signaling through electronics 511 (as partially depicted in FIG. 15). The signaling from the push-pull transducer 105 indicates if the active rod is under tension or compression, and the magnitude of such force. This signaling in turn drives a colored lamp such as an LED that is contained in the optics end 103, and will be further described herein. The optics end 103 comprises at least one light source such as a light emitting diode (LED), and is part of the passive end body 513 that is in turn connected to a second plug 515.

To better describe the plugs of the active rod, FIG. 6 is a plan view of the end of a plug of the active rod of FIG. 5. In some embodiments of the present invention, the first plug 509 and the second ping 515 are substantially the same or similar. This allows for the placement of either end of the active rod 101 in a connector socket. A first contact prong 601, a second contact prong 603 and a third contact prong 605 can be seen placed circumferentially around the connector body 607. As previously stated, each contact prong contains an angle, a dimple, a bend or similar feature placed along its length such that it will contact the appropriate conductive ring or arc of the connector it is joined to.

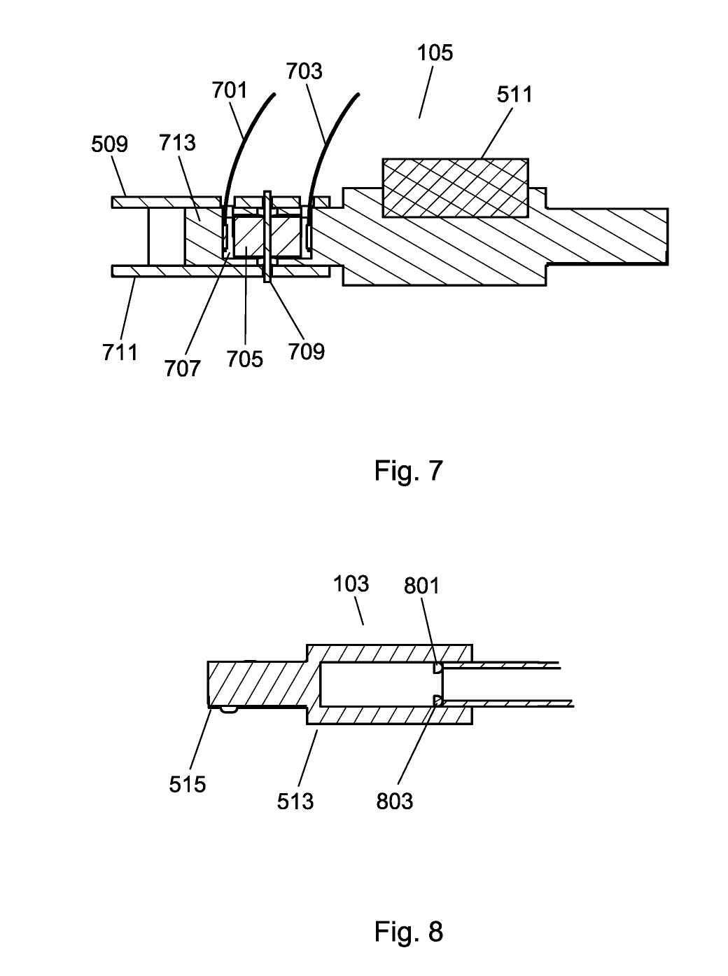

FIG. 7 is a partial cross sectional view of the push-pull transducer end 105 of the active rod 101 taken along line A-A of FIG. 6. As can be seen in FIG. 7, compression of the active rod 101 translates into a force that acts upon the first force sensitive resistor 701, and tension of the active rod 101 translates into a force that acts upon the second force sensitive resistor 703. This is accomplished by the mechanical interaction of the actuator piston 705 within the cylinder 707. An inner cylinder sleeve 713 cooperates with an outer cylinder sleeve 711 where a retention pin 709 or similar such retention structure allows limited linear travel of the actuator piston 705 in either direction, allowing for pressure on either the first force sensitive resistor 701 or the second force sensitive resistor 703 depending on whether the connected active rod 101 is under compression or tension. The force sensitive resistors provide a resistance that changes with respect to the force that it receives from the actuator piston 705. In some embodiments of the present invention, force sensitive capacitors, piezoelectric devices, diodes, transistors, coils, sensors or other such devices may be used in place of, or in conjunction with, the force sensitive resistors. The variation in resistance or other electrical variable in turn changes the intensity of the light source that illuminates the active rod 101. The brighter the light from the active rod, the more force that is being applied to the active rod. Thresholds can also be set such that when the force exceeds a set threshold, the light source will blink, change color, or otherwise alert the user to the threshold limit being exceeded.

Through the electronics 511 that will be further described by way of FIG. 15, a first light source 801 and in some embodiments a second light source 803, are activated by way of a power source that is coupled to the previously described force sensitive resistors. One light source is activated upon receiving a signal from the push-pull transducer that the active rod is in compression, and the other light source is alternatively activated upon receiving a signal from the push-pull transducer that that active rod is in tension.

FIG. 8 is a partial cross sectional view of the optics end of the active rod taken along line A-A of FIG. 6. A first light source 801 and a second light source 803 can be seen. In some embodiments of the present invention, the light sources are light emitting diodes. Wires or similar conductive traces pass along the length of the active rod to provide power and signaling from one end of the active rod to the other end, and to other active rods by way of connectors.

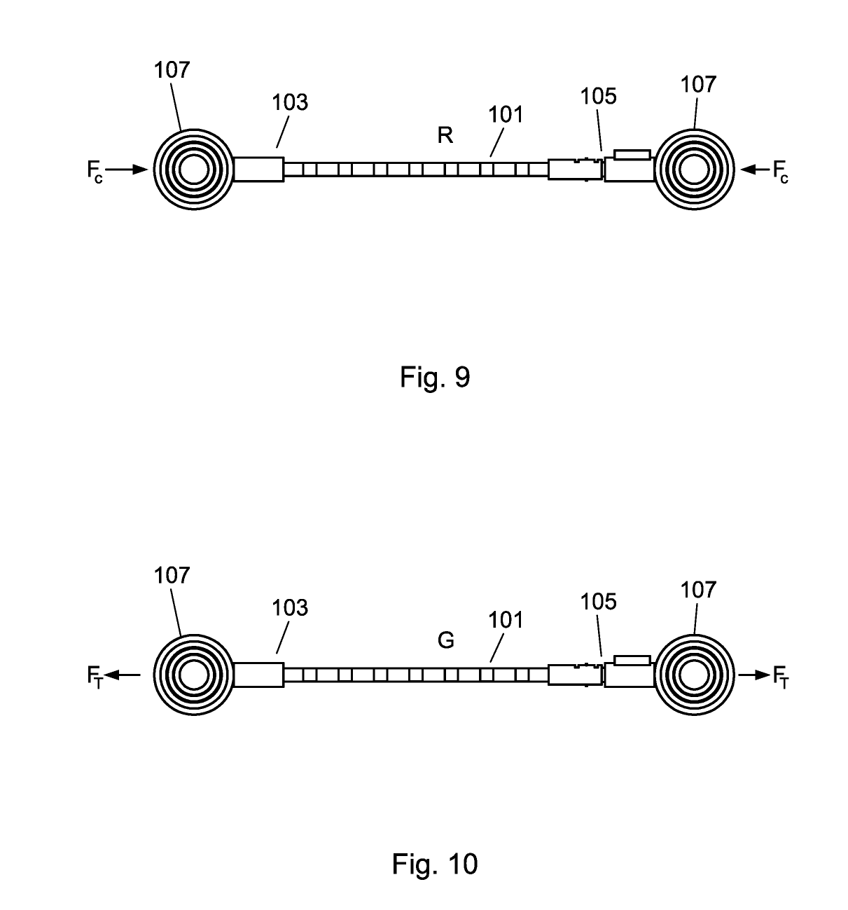

FIG. 9 is a plan view of an active rod with two X-Y connectors tinder compression. In this example, the active rod 101 is labeled with an R, indicating that the color red is being displayed to alert the user that the active rod 101 is under compression. In a similar manner, FIG. 10 is a plan view of an active rod with two X-Y connectors under tension. In this example, the active rod 101 is labeled with a G, indicating that the color green is being displayed to alert the user that the active rod 101 is under tension.

Many varied structures can be built with LumenLinks™, the responsive construction toy of the present invention.

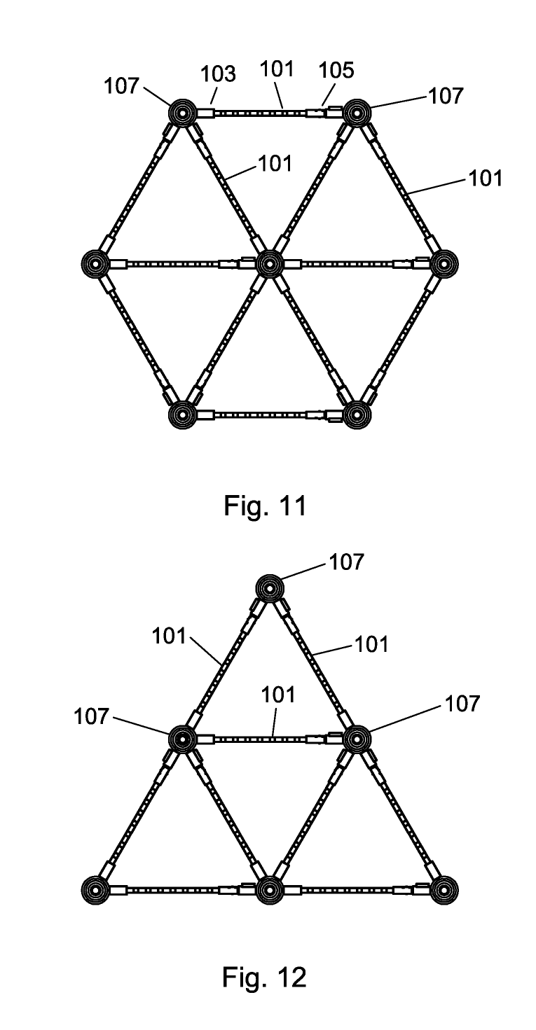

FIG. 11 is a plan view of an example of a responsive construction toy built item of the present invention, and FIG. 12 is a plan view of another example of a responsive construction toy built item of the present invention.

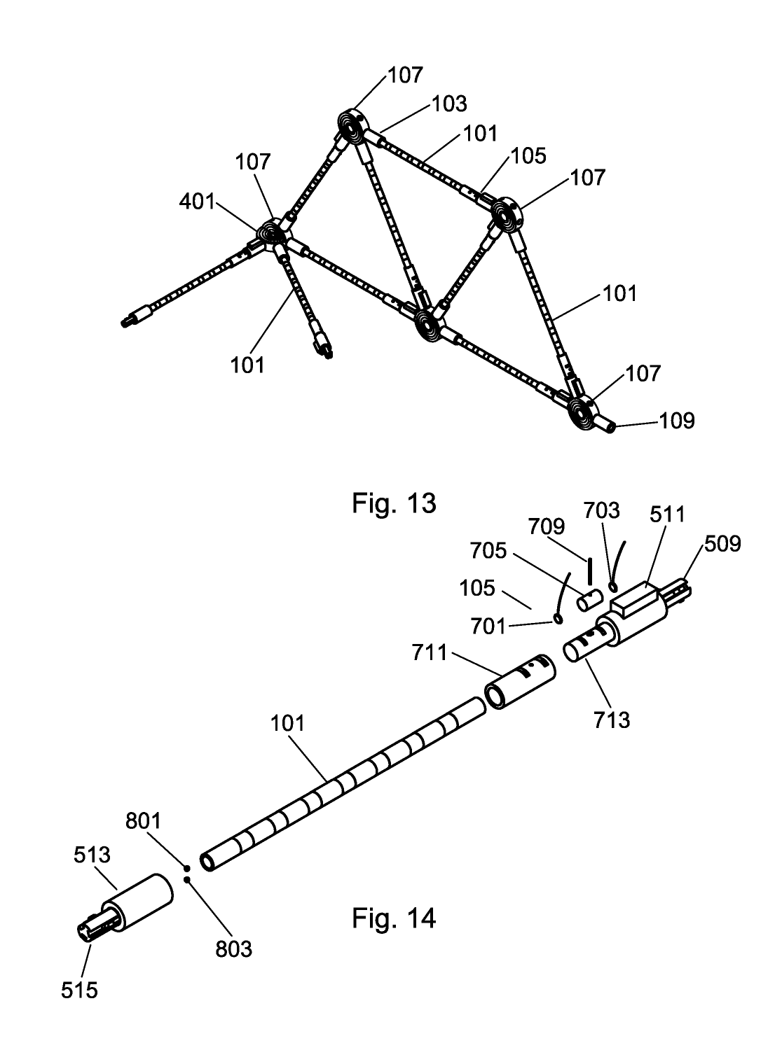

To create three dimensional structures, FIG. 13 is a plan view of an example of a responsive construction toy built item of the present invention that uses both X-Y connectors 107 as well as Z connectors 401.

FIG. 14 is an exploded perspective view of an active rod of the present invention that fully depicts the components of the active rod and the interaction between them. The wires or conductive traces that travel from one end of the active rod to the other cannot be seen.

Lastly, FIG. 15 is a circuit diagram of the push-pull transducer electronics of the present invention. Additional circuits that provide power, signaling, or additional functionality such as blinking, sounds, or the like, may also be included herein. The force sensitive resistors FSR1 and FSR2 are arranged in a voltage divider configuration at the input to an op-amp arranged in a voltage follower configuration that in turn drives a forward biased LED and a reverse biased LED. Depending on which force sensitive resistor is activated, and hence which direction current flows through the circuit, either the forward biased green LED will turn on or the reverse biased red LED will turn on. In addition, the intensity of the light is proportional to the force that is being applied to the force sensitive resistor.

What is claimed is:

1. A responsive construction toy comprising:
An active rod comprising a generally elongated member having a first end and a second end, a first plug mechanically coupled to the first end of the generally elongated member, a second plug mechanically coupled to the second end of the generally elongated member, an optics end component electrically and mechanically coupled to the generally elongated member, and a push-pull transducer end mechanically coupled to the generally elongated member; and
an X-Y connector comprising a first conductive ring, a second, conductive ring concentric with the first conductive ring and electrically separated from the first conductive ring by an insulator, and a third conductive ring concentric with the second conductive ring and electrically separated from the second, conductive ring by an insulator, a plurality of X-Y sockets arranged circumferentially about the X-Y connector and passing radially inward, and a Z socket concentric with the conductive rings.

2. The responsive construction toy of claim 1, further comprising a Z connector comprising a first conductive arc, a second conductive arc concentric with the first conductive arc and electrically separated from the first conductive arc by an insulator, and a third conductive arc concentric with the second conductive arc and electrically separated from the second conductive arc by an insulator, a plurality of X-Y sockets arranged circumferentially about the Z connector and passing radially inward, and a Z plug for insertion into a X socket of an X-Y connector.

3. The responsive construction toy of claim 1, wherein the generally elongated member of the active rod is optically conductive.

4. The responsive construction toy of claim 1, wherein the optics end component of the active rod comprises a first light source and a second light source.

5. The responsive construction toy of claim 1, wherein the generally elongated member of the active rod comprises light transmission bands.

6. The responsive construction toy of claim 1, wherein the push-pull transducer of the active rod comprises a first force sensitive resistor that changes resistance in response to compression and a second force sensitive resistor that changes resistance in response to tension.

7. The responsive construction toy of claim 6 wherein the active rod further comprises an actuator piston that translates compression of the active rod into pressure on the first force sensitive resistor and tension of the active rod into pressure on the second force sensitive resistor.

8. The responsive construction toy of claim 1, further comprising a power feed for insertion into an X-Y connector.

9. The responsive construction toy of claim 1, wherein the first plug of the active rod comprises a connector body, a first contact prong, a second contact prong and a third contact prong.

10. The responsive construction toy of claim 1, wherein the second plug of the active rod comprises a connector body, a first contact prong, a second contact prong and a third contact prong.

11. An active rod for a responsive construction toy, the active rod comprising a generally elongated member having a first end and a second end, a first plug mechanically coupled to the first end of the generally elongated member, a second plug mechanically coupled to the second end of the generally elongated member, an optics end component electrically and mechanically coupled to the generally elongated member, and a push-pull transducer end mechanically coupled to the generally elongated member.

12. The active rod of claim 11, wherein the generally elongated member is optically conductive.

13. The active rod of claim 11, wherein the optics end component comprises a first light source and a second light source.

14. The active rod of claim 11, wherein the generally elongated member comprises light transmission bands.

15. The active rod of claim 11, wherein the push-pull transducer comprises a first force sensitive resistor that changes resistance in response to compression and a second force sensitive resistor that changes resistance in response to tension.

16. The active rod of claim 15, wherein the active rod further comprises an actuator piston that translates compression of the active rod into pressure on the first force sensitive resistor and tension of the active rod into pressure on the second force sensitive resistor.

17. The active rod of claim 11, wherein the first plug comprises a connector body, a first contact prong, a second contact prong and a third contact prong.

18. The active rod of claim 11, wherein the second plug comprises a connector body, a first contact prong, a second contact prong and a third contact prong.

19. An X-Y connector for a responsive construction toy, the X-Y connector comprising a first conductive ring, a second conductive ring concentric with the first conductive ring and electrically separated from the first conductive ring by an insulator, and a third conductive ring concentric with the second conductive ring and electrically separated from the second, conductive ring by an insulator, a plurality of X-Y sockets arranged circumferentially about the X-Y connector and passing radially inward, and a Z socket concentric with the conductive rings.

20. A Z connector for a responsive construction toy, the Z connector comprising a first conductive arc, a second conductive are concentric with the first conductive arc and electrically separated from the first conductive are by an insulator, and a third conductive are concentric with the second conductive arc and electrically separated from the second conductive are by an insulator, a plurality of X-Y sockets arranged circumferentially about the Z connector and passing radially inward, and a Z plug for insertion into a Z socket of an X-Y connector.
